(19) United States
(12) Patent Application Publication
(10) Pub. No.: US 2022/0126532 A1
(43) Pub. Date: Apr. 28, 2022

(54) SYSTEM AND METHOD FOR IN-SITU IMPREGNATION OF CONTINUOUS FIBER TOWS WITH THERMOPLASTIC RESIN

(71) Applicant: RENSSELAER POLYTECHNIC INSTITUTE, Troy, NY (US)

(72) Inventors: James John GAROFALO, Garden City, NY (US); Daniel F. WALCZYK, Troy, NY (US)

(73) Assignee: RENSSELAER POLYTECHNIC INSTITUTE, Troy, NY (US)

(21) Appl. No.: 17/435,096

(22) PCT Filed: Mar. 2, 2020
(86) PCT No.: PCT/US20/20601

§ 371 Date: Aug. 31, 2021

Related U.S. Application Data
(60) Provisional application No. 62/812,596, filed on Mar. 1, 2019.
(60) Provisional application No. 62/981,242, filed on Feb. 25, 2020.

(51) Int. Cl. B29C 70/52; D02J 1/18; D06N 7/00; B33Y 70/10

(52) U.S. Cl. CPC B29C 70/521; D02J 1/18; B29K 2101/12; B33Y 70/10; D06N 7/00

(57) ABSTRACT

A method and system for impregnating a source of fiber tow is provided. A stream of fiber tow is drawn through a tow guide to align the fiber tow with a predetermined path. The stream is drawn in tension across a series of tow spreader pins, that include convex spreading surface aligned with the predetermined tow path. As the fiber tow is drawn over spreading surfaces, the fibers tend to spread and/or fan out along that surface. The stream of fiber tow now being spread to a greater width and reduced thickness, the spread fiber tow is drawn through an impregnation die that includes a plurality of resin supply conduits. Resin melt is applied to the spread fiber tow from one or more directions to fully impregnate the fiber tow. The prepreg fiber tow is then drawn to a converging die which removes excess resin and converge to a fiber tow product. An angled drive roller is utilized to pull the fiber tow with sufficient force to overcome dry and viscous friction in the system components.

### CROSS REFERENCE TO RELATED APPLICATION(S)

This application is a national stage filing of International Patent Application No. PCT/US2020/020601, filed Mar. 2, 2020, which claims the benefit of U.S. Provisional Application Nos. 62/812,596, filed Mar. 1, 2019, and 62/981,242, filed Feb. 25, 2020, which is incorporated by reference as if disclosed herein in its entirety.

### BACKGROUND

The thermoplastic composite industry has seen significant growth in recent years, expecting to reach $9.9 Billion by 2020, as an alternative to traditional thermoset composites, mostly due to the advantages of shorter processing times, higher impact strength, and recyclability. In addition, the reformability of thermoplastics makes thermoplastic composites an ideal candidate for additive manufacturing.

Additive manufacturing (AM) is a process of joining materials to make objects from 3D model data, usually layer upon layer, as opposed to subtractive manufacturing methodologies. Generally there are five overall steps to AM: (1) CAD file, (2) Convert to .STL format, (3) Slice.STL file into cross sectional layers, (4) Print the part by building each layer atop one another, and (5) Clean and finish the part. AM has been around since the 1980s but more recently there has been a boom both technologically and socially. New material systems, such as metal powders, are allowing AM to be used to directly print actual parts instead of just prototypes and prototype tooling. Socially speaking it is gaining favor among the non-engineering peoples of the world since the most basic, cheap, and easy to use process, Fused Deposition Modeling (FDM), is now entering the home. It can now be legally copied by numerous manufacturers and can be made cheaply which makes it abundant in the market. There are many AM processes that have been developed. Some of the more widely used include FDM, Stereolithography (SLA), 3D Inkjet Printing (3DP), and Selective Laser Sintering or Melting (SLS/SLM), however more and more processes are being developed by the day.

Several organizations are already starting to investigate. Most of these groups, such as NASA and Cincinnati Inc./Oak Ridge National Laboratory, are using short fiber composites by introducing chopped fiber into a thermoplastic extruder or making short fiber reinforced filament and then using a standard fused deposition modeling (FDM) printer. The main issue here is that short fiber, and not continuous fiber, reinforcement is used. The composites industry is well aware that the real strength in composites comes from alternating layers of continuous uni-directional fibers, or layering woven fabrics, and thus an AM process utilizing this structure would be ideal to match industrial needs for rapid manufacturing (not high production) and prototyping. Additionally, there is at least one company that is currently commercializing continuous reinforced thermoplastic AM, Markforged, however their machines only have in-plane reinforcement like FDM machines and use extremely expensive preimpregnated carbon fiber tows.

The two most common reinforcement materials are carbon fibers and glass fibers. These reinforcements typically come in a number of forms such as continuous fiber tows (similar to rope), woven fabrics, and chopped fiber (loose or mats). Thermoplastic prepregs (fiber materials pre-impregnated with matrix) come in powder or pellet sprinkled woven sheet form for press-like operations, chopped fiber inside polymer pellets for extrusion processes, or uni-directional composite tapes for use in automated fiber placement (AFP). AFP is actually a type of AM where a robotic system places composite material one ply at a time, typically wrapping around a core or mandrel, to build up the composite part.

Thermoplastic composites are a composite material, meaning a combination of two or more materials, where a thermoplastic polymer is reinforced with a fibrous material to make something stronger than each of the materials individually. Currently continuous fiber tows are most commonly impregnated through dispersion coating, whereby dry fiber tow spread into a thin strip is immersed in a bath of slurry consisting of thermoplastic powder dispersed in an aqueous solution, then the impregnated tow is dried and run beneath infrared heaters to melt the thermoplastic and consolidate the fibers. Another similar process uses thermoplastic polymer dissolved in a solvent as the carrier. After bath immersion, the solvent is flashed off and coated fibers are consolidated as before. Manufacturing costs for both the dispersion coating and solvent coating methods are quite high. A lower cost method used for lower quality prepreg, such as polypropylene/E-glass, involves pull dry fiber through an undulating die while molten thermoplastic resin is injected early in the fiber path. The fiber tow's tortuous path can result in significant fiber damage. Fiber tows are also impregnated by electrostatic charge to attract thermoplastic powder, by spreading them and immersing them in resin baths, or by coating and consolidating processes. In the aforementioned impregnation methods, The aforementioned impregnations methods are typically used to make large width rolls, so narrow width tape (e.g., 3.2, 6.4, 12.7 and 25.4 mm) used for additive manufacturing and automated fiber placement are made by slitting the wide rolls. Lastly, thermoplastic composites are currently being manufactured additively, however they have flaws such as being limited to short fiber reinforcement or by having a continuous reinforcement structure that is only in flat, parallel planes or layers using extremely expensive materials.

### SUMMARY

Accordingly, some embodiments of the present disclosure relate to a system for impregnating a fiber tow, e.g., with thermoplastic resin, including a source of fiber tow, the fiber tow having a first thickness; a tow spreader including one or more spreading surfaces, the spreading surfaces configured to spread the fiber tow from the source of fiber tow to form a spread fiber tow having second thickness, wherein the first thickness is greater than the second thickness; an impregnation die positioned to receive the spread fiber tow; a resin extruder configured to deliver the resin to the resin supply conduits; and a drive assembly rotating at substantially constant rotation speed configured to continuously transport a fiber tow from the source and through the tow spreader and impregnation die. In some embodiments, the system includes a converging die configured to remove excess resin from the prepreg fiber tow, shape the prepreg fiber tow into a two-dimensional cross-sectional shape, e.g., circle, rectangle, etc., converge the prepreg fiber tow to a third thickness, wherein the third thickness is greater than the second thickness, or combinations thereof.

In some embodiments, the impregnation die includes one or more thermoplastic resin supply conduits; and a fiber tow slit positioned between the resin supply conduits, the fiber tow slit configured to contact the spread fiber tow with a resin from the resin supply conduits on one or both sides of the tow to form a prepreg fiber tow to form a prepreg fiber tow. In some embodiments, the fiber tow includes carbon, glass, one or more polymers, one or more minerals, or combinations thereof. In some embodiments, the resin includes polyether ether ketone, polyether ketone ketone, polysulfone, polyethersulfone, polyether imide, polyamide, polybutylene terephthalate, nylon, polyethylene, polycarbonate, or combinations thereof or other resins used for thermoplastic composites. In some embodiments, the source of fiber tow includes one or more spools of fiber tow, wherein the source of fiber tow includes a friction brake to provide torsional resistance to rotation of the spools and/or slight tension in the fiber tow. In some embodiments, the impregnation die includes a first resin supply conduit and a second resin supply conduit, wherein the first resin supply conduit is positioned to deliver resin to the fiber tow slit from a first direction and the second supply conduit is positioned to simultaneously deliver resin to the fiber tow slit from a second direction, wherein the first direction is opposite the second direction. In some embodiments, the first direction is from above the spread fiber tow and the second direction is from below the spread fiber tow. In other embodiments, resin is delivered to the fiber tow from only one direction, e.g., from above, below, etc.

In some embodiments, the spreading surfaces have a longitudinal axis perpendicular to the fiber tow in the tow spreader, the spreading surfaces having a convex surface profile along the longitudinal axis. In some embodiments, the convex surface profile has a constant radius of curvature. In some embodiments, the tow spreader includes one or more rotating or non-rotating pins, wherein one or more of the spreading surfaces are positioned on the pins. In some embodiments, at least one of the pins includes a radial groove having a planar surface profile.

In some embodiments, the drive assembly includes a speed-controlled drive roller, wherein a longitudinal axis of the drive roller is positioned at an angle Θ relative to the fiber tow, wherein the angle Θ is less than 90°. In some embodiments, the drive roller has a diameter greater than about 10 cm.

In some embodiments, the system includes a post-processing assembly positioned between the converging die and cooling assembly to improve prepreg quality.

Some embodiments of the present disclosure related to a system for impregnating a fiber tow including a source of fiber tow; a tow guide to align the fiber tow from the fiber tow source along a predetermined tow path; a plurality of tow spreader pins, at least one of the tow spreader pins including a convex spreading surface aligned with the predetermined tow path to spread the fiber tow to a spread fiber tow; an impregnation die positioned to receive the spread fiber tow; a converging die configured to remove excess resin from and converge the prepreg fiber tow; and a drive roller configured to pull the fiber tow from the source and through the tow guide, tow spreader pins, impregnation die, and converging die, wherein a longitudinal axis of the drive roller is positioned at an angle Θ relative to the fiber tow. In some embodiments, the system includes a cooling assembly positioned between the converging die and the drive roller. In some embodiments, the fiber tow is wound onto a take-up reel.

In some embodiments, the impregnation die includes at least a first resin supply conduit and at least a second resin supply conduit; a fiber tow slit positioned between the first resin supply conduit and the at least a second resin supply conduit and configured to contact the spread fiber tow with a resin from the resin supply conduits to form a prepreg fiber tow; and a heating element configured to maintain a predetermined temperature within the first resin supply conduit and the at least a second resin supply conduit, wherein the first resin supply conduit is positioned to deliver resin to the fiber tow slit from a first direction and the at least a second resin supply conduit is positioned to simultaneously deliver resin to the fiber tow slit from a second direction, wherein the first direction is opposite the second direction. In other embodiments, resin is delivered to the fiber tow from only one direction, e.g., from above, below, etc.

Some embodiments of the present disclosure are directed to a method for impregnating a fiber tow, the method including providing a source of fiber tow; drawing a fiber tow from the source through a tow guide to align the fiber tow along a predetermined tow path; drawing the fiber tow over a plurality of tow spreader pins, at least one of the tow spreader pins including a convex spreading surface aligned with the predetermined tow path to spread the fiber tow to a spread fiber tow; drawing the spread fiber tow to an impregnation die, the impregnation die including a first resin supply conduit, at least a second resin supply conduit, and a fiber tow slit positioned between the first resin supply conduit and the at least a second resin supply conduit; simultaneously drawing the spread fiber tow through the fiber tow slit and extruding a resin through the first resin supply conduit and the at least a second resin supply conduit to the fiber tow slit to form a prepreg fiber tow; drawing the prepreg fiber tow through a converging die configured to remove excess resin from and converge the prepreg fiber tow; and collecting the converged prepreg fiber tow. In some embodiments, the prepreg fiber tow is drawn through a post-processing assembly to improve prepreg quality. In some embodiments, the method includes cooling the prepreg fiber tow after the converging die. In some embodiments, the fiber tow is wound onto a take-up reel.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is a schematic representation of a system for impregnating a fiber tow according to some embodiments of the present disclosure;

FIG. 1B is a schematic representation of a system for impregnating a fiber tow according to some embodiments of the present disclosure;

FIG. 2 is a schematic representation of a source of fiber tow according to some embodiments of the present disclosure;

FIG. 3A is a schematic representation of a fiber tow spreader according to some embodiments of the present disclosure;

FIG. 3B is a schematic representation of a fiber tow spreader according to some embodiments of the present disclosure;

FIG. 3C is a schematic representation of a fiber tow spreader according to some embodiments of the present disclosure;

FIG. 3D is a schematic representation of a fiber tow spreader according to some embodiments of the present disclosure;

FIG. 4A is a schematic representation of a fiber impregnation die according to some embodiments of the present disclosure;

FIG. 4B is a schematic representation of a fiber impregnation die according to some embodiments of the present disclosure;

FIG. 4C is a schematic representation of a fiber impregnation die according to some embodiments of the present disclosure;

FIG. 5 is a schematic representation of a system for impregnating a fiber tow according to some embodiments of the present disclosure; and

FIG. 6 is a chart of a method of for impregnating a fiber tow according to some embodiments of the present disclosure.

### DETAILED DESCRIPTION

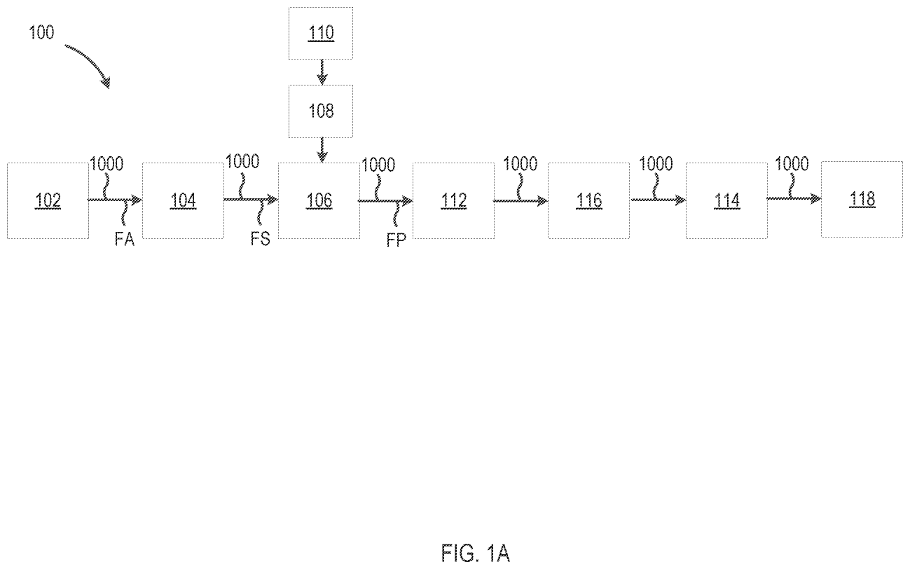

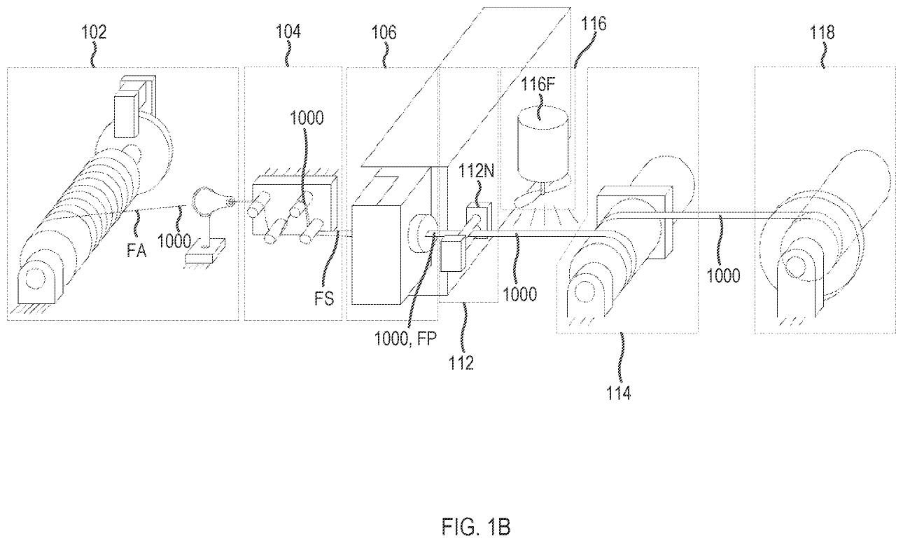

Referring now to FIGS. 1A and 1B, some embodiments of the present disclosure are directed to a system 100 for impregnating a stream 1000 of fiber tow. As used herein, a “fiber tow” refers to a bundle of a plurality of individual continuous or semi-continuous fibers. In some embodiments, stream 1000 is continuous or semi-continuous. In some embodiments, the fiber tow in stream 1000 includes greater than about 10 individual fibers, greater than about 50 individual fibers, greater than about 100 individual fibers, greater than about 500 individual fibers, greater than about 1000 individual fibers, greater than about 5000 individual fibers, greater than about 10000 individual fibers, etc. Further, as used herein, the “thickness” of the fiber tow at any given location in system 100 refers the average number of fibers across the vertical cross-section of the fiber tow. In some embodiments, the fiber tow includes fibers composed of carbon, glass, one or more polymers, one or more minerals, or combinations thereof.

In some embodiments, system 100 includes a source 102 of fiber tow for impregnation with one or more resins via system 100, as will be discussed in greater detail below. In some embodiments, source 102 includes one or more spools of fiber tow. Source 102 is configured to provide a continuous and/or semi-continuous feed of fiber tow to the other components of system 100. As will become clear in the discussion below, the fiber tow feed may occasionally be operated “semi-continuously” in the sense that the supply of fiber tow may be exhausted and operation of system 100 may be temporarily halted in replenish that supply. However, the present disclosure also contemplates embodiments in which the supply of fiber tow is replenished without interrupting operation of system 100. Further, when source 102 includes a supply of fiber tow, fiber tow can be fed continuously to other components of system 100 and the system can be operated continuously. In some embodiments, fiber tow from source 102 has a first thickness.

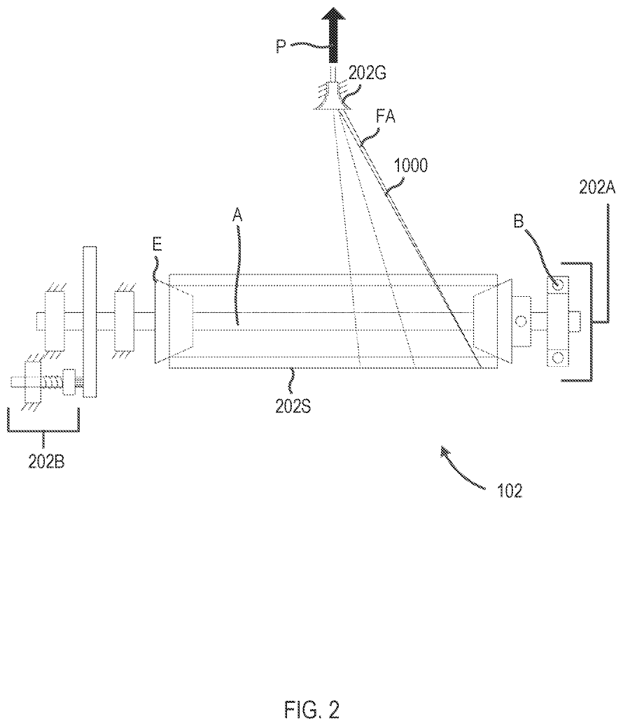

Referring now to FIG. 2, in some embodiments, source 102 includes a spool 202S of fiber tow. Fiber tow is drawn from spool 202S to provide stream 1000 of the fiber tow in system 100. In some embodiments, source 102 includes any mechanism suitable to maintain fiber tow in a desired spatial orientation and location while also enabling the fiber tow to be drawn to the other components of system 100 as stream 1000. In some embodiments, source 102 includes an axle assembly 202A. In some embodiments, spool 202S is provided on axle assembly 202A, via which the spool can rotate to facilitate continuous feeding of fiber tow. In some embodiments, axle assembly 202A includes one or more axles A, endcaps E, roller bearings B, etc., as needed to facilitate rotation of spool 202S. In some embodiments, axle assembly 202A includes a friction brake 202B to provide torsional resistance to feed of fiber tow FA and thus drawing of stream 1000 through system 100, e.g., resistance to rotation of spool 202S. In part, this torsional resistance helps prevent fiber tow, e.g., fiber tow FA from unraveling while traversing the components of system 100.

In some embodiments, as system 100 depletes fiber tow from source 102, the source is replenished, e.g., by removing depleted spool 202S and installing a new spool of fiber tow, switching stream 1000 of fiber tow from depleted spool 202S to originating from a new spool, etc. In some embodiments, system 100 includes one or more tow guides 202G. In some embodiments, tow guides 202G are configured to align stream 1000 from source 102 along a predetermined tow path P.

Referring again to FIGS. 1A and 1B, in some embodiments, fiber tow from source 102, e.g., fiber tow FA, is drawn, e.g., along predetermined tow path P, to a tow spreader 104. In some embodiments, tow spreader 104 is configured to spread fiber tow to form a spread fiber tow FS having a second thickness. In some embodiments, the first thickness, e.g., of fiber tow FA, is greater than the second thickness, e.g., of spread fiber tow FS. In some embodiments, the second thickness is as thin as possible while maintaining uniform or substantially uniform distribution of fibers across the width of the spread fiber tow. In some embodiments, the second thickness is at least one fiber in thickness. In some embodiments, the second thickness is greater than one fiber in thickness.

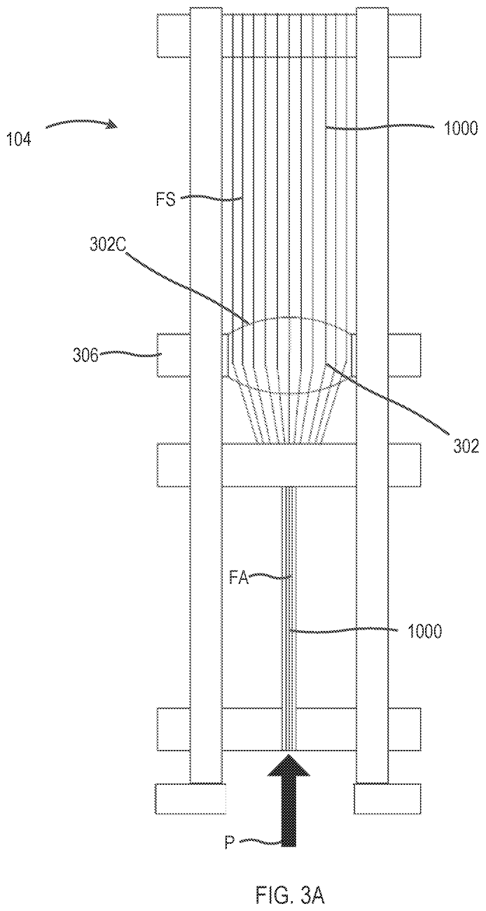

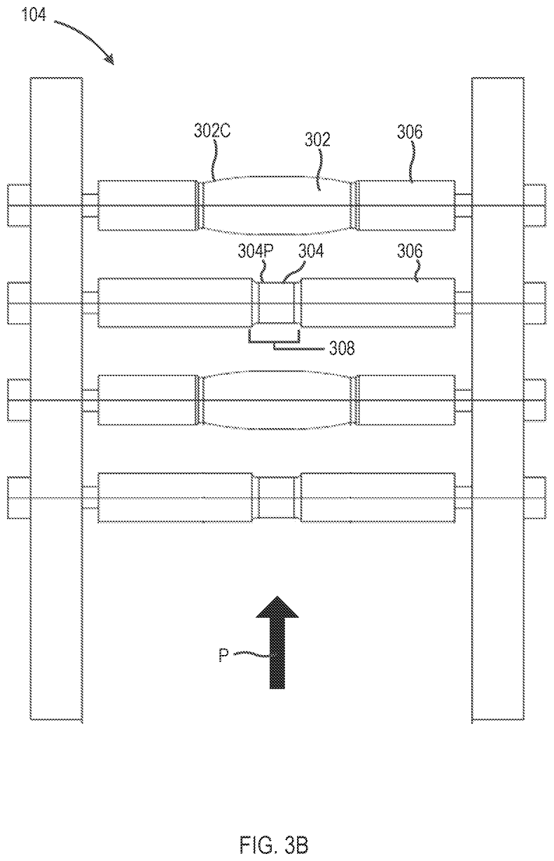

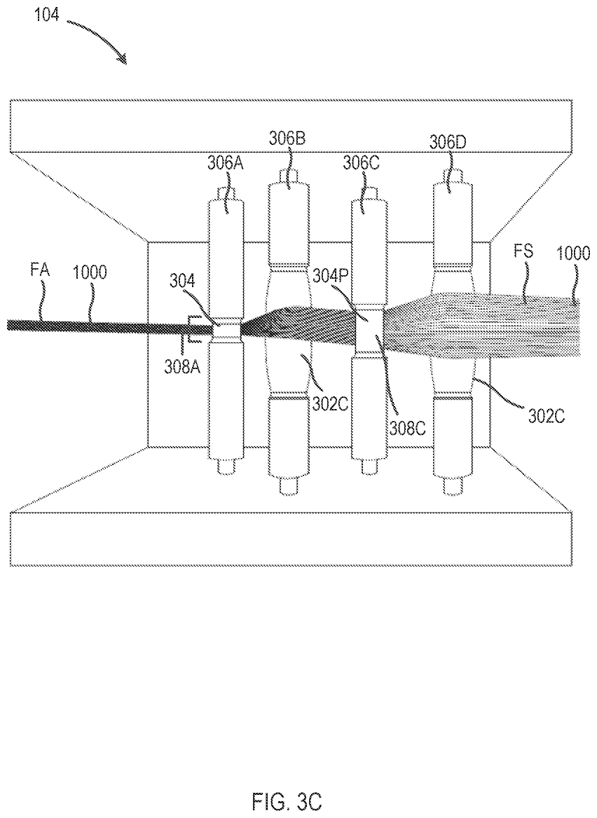

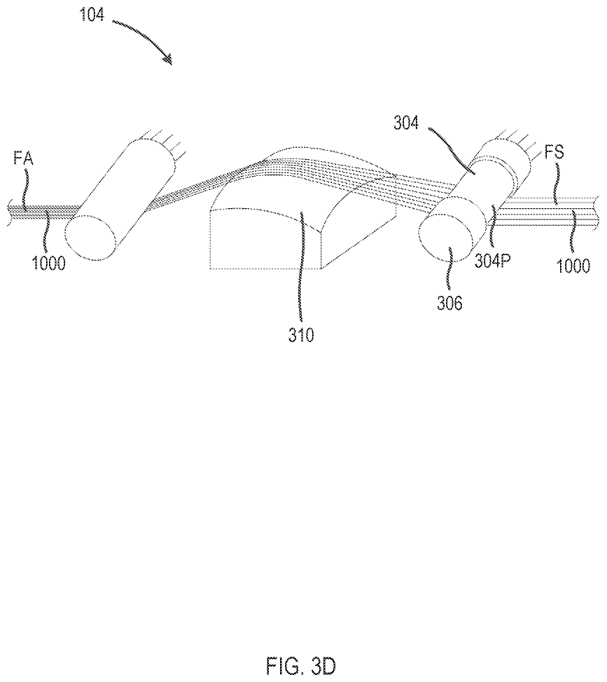

Referring now to FIGS. 3A-3C, in some embodiments, tow spreader 104 includes one or more spreading surfaces 302. In some embodiments, spreading surfaces 302 are configured to spread the fiber tow in stream 1000, e.g., fiber tow FA, to form spread fiber tow FS having the second thickness. Referring specifically to FIG. 3B, in some embodiments, spreading surfaces 302 have a longitudinal axis perpendicular to the fiber tow in the tow spreader, e.g., perpendicular to fiber tow stream 1000, predetermined tow path P, etc. In some embodiments, spreading surfaces 302 are aligned with, i.e., in the draw path of, stream 1000, predetermined tow path P, etc. In some embodiments, spreading surfaces 302 having a convex surface profile 302C along the longitudinal axis. As the fiber tow is drawn over spreading surfaces 302 in tension, the fibers tend to spread and/or fan out along that surface. As best exemplified in FIGS. 3A and 3C, as the fiber tow spreads, the average number of fibers decreases vertically. In some embodiments, convex surface profile 302C has a constant radius of curvature. In some embodiments, each spreading surface 302 has the same convex surface profile 302C. In some embodiments, spreading surfaces 302 have two or more convex surface profiles 302C, e.g., different spreading surfaces have convex surface profiles with different radii of curvature. In some embodiments, the convex surface profiles 302C have a series of narrow V-grooves oriented in the direction of fiber travel to enhance the spreading effect. In some embodiments, tow spreader 104 includes one or more width-stabilizing surfaces 304. In some embodiments, width-stabilizing surfaces 304 include planar surface profiles 304P. These stabilizing surfaces are configured to provide wrapping and sliding stability.

In some embodiments, tow spreader 104 includes one or more tow spreader pins 306. In some embodiments, pins 306 can be rotating pins, non-rotating pins, or combinations thereof. In some embodiments, tow spreader 104 includes two or more tow spreader pins 306. In some embodiments, one or more spreading surfaces 302 are positioned on pins 306. In some embodiments, at least two pins 306 include a spreading surface 302. In some embodiments, pins 306 include spreading surfaces 302 with the same radius of curvature. In some embodiments, separate pins 306 in tow spreader 104 include spreading surfaces 302 with different radii of curvature. In some embodiments, one or more width-stabilizing surfaces 304 are positioned on pins 306. In some embodiments, at least one of pins 306 includes a radial groove 308 having a planar surface profile 304P.

As shown specifically in FIG. 3D, in some embodiments, tow spreader 104 includes one or more non-pin spreading surfaces 310. In some embodiments, tow spreader pins 306 and non-pins 310 are aligned perpendicular to the fiber tow in the tow spreader, e.g., perpendicular to fiber tow stream 1000, predetermined tow path P, etc.

Using tow spreader 104 of FIG. 3C as an example, fiber tow FA entering the tow spreader is stabilized by radial groove 308A in first pin 306A. Fiber tow FA is then evenly spread by convex spreading surface 302C of second pin 306B. The partially-thinned fiber tow FA is further stabilized by radial groove 308C on third pin 306C. Fiber tow FA is spread again by the convex spreading surface 302C of fourth (and in this exemplary embodiment, last) pin 306D, to form a spread fiber tow FS which is drawn from tow spreader 104, as will be discussed in greater detail below. In some embodiments, the final surface of tow spreader 104, i.e., the last surface fiber tow FA interacts with before the fiber tow leaves tow spreader 104 as spread fiber tow FS, includes a convex spreading surface 302C. In some embodiments, the final surface of tow spreader 104 includes a planar surface profile 304P.

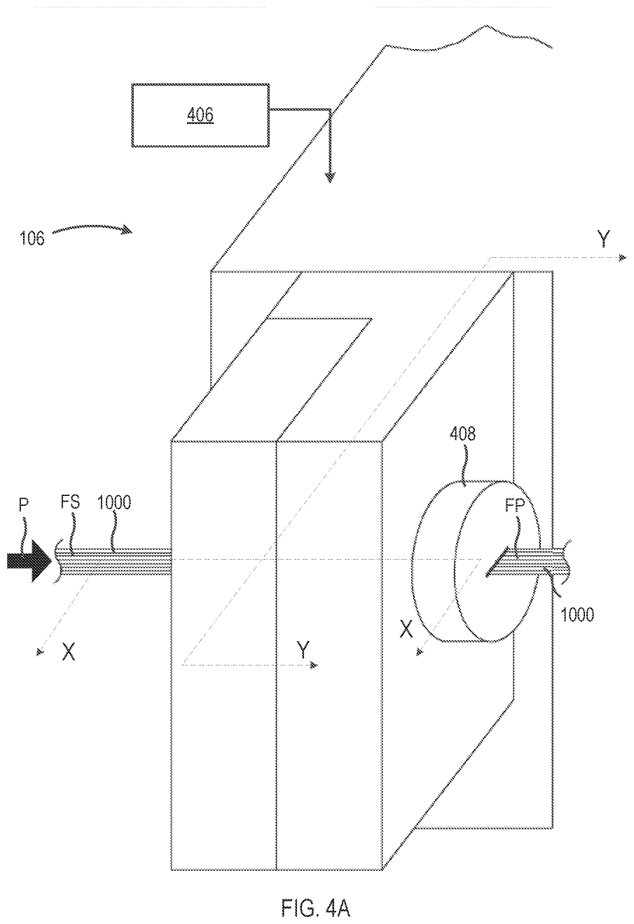

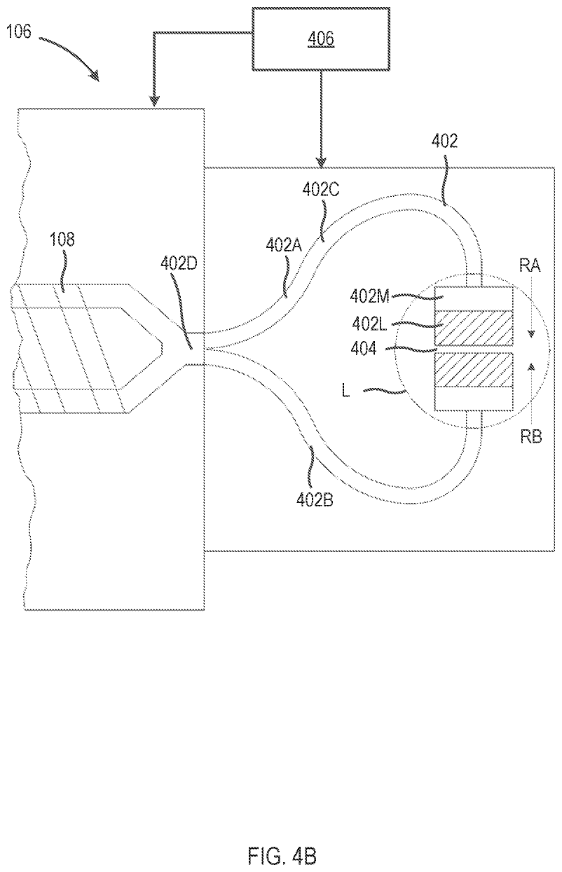

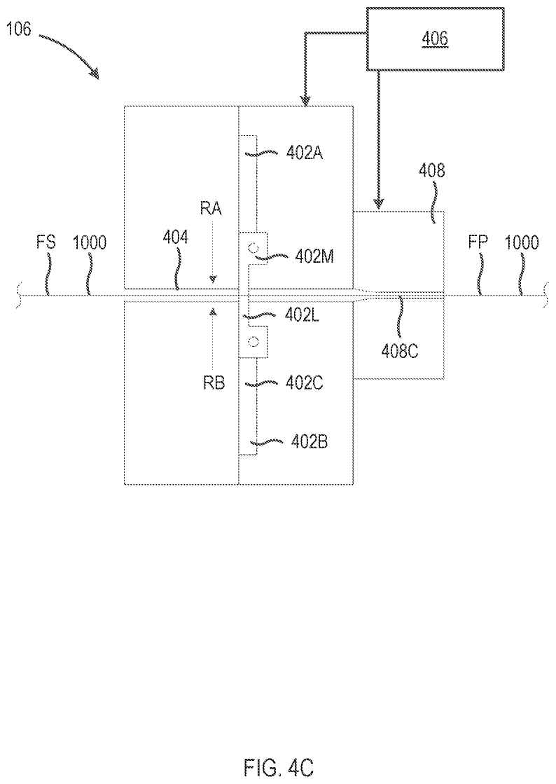

Referring again to FIGS. 1A and 1B and further to FIG. 4A, in some embodiments, fiber tow, e.g., spread fiber tow FS from tow spreader 104, is drawn, e.g., along predetermined tow path P, to an impregnation die 106. In some embodiments, impregnation die 106 is positioned to receive fiber tow, e.g., stream 1000, spread fiber tow FS, etc., and is configured to contact the fiber tow with resin. In some embodiments, impregnation die 106 includes one or more resin supply conduits. In some embodiments, impregnation die 106 includes one or more fiber tow slits configured to receive fiber tow, e.g., stream 1000, spread fiber tow FS, portions thereof, etc., and contact the fiber tow with resin, e.g., from the resin supply conduits, to form a prepreg fiber tow FP. Likewise, the resin supply conduits are configured to deliver resin to the fiber tow slit for contacting the fiber tow positioned therein. In some embodiments, impregnation die 106 includes a heating element configured to maintain a predetermined temperature in the die, in the resin, within the resin supply conduits, or combinations thereof. In some embodiments, impregnation die 106 includes one or more layers of insulation to assist in maintaining the predetermined temperature and reducing convective and radiative heat loss.

In some embodiments, system 100 includes one or more resin extruders 108. In some embodiments, resin extruder 108 is configured to deliver resin to the resin supply conduits in impregnation die 106. In some embodiments, resin extruder 108 is in fluid communication with both the resin supply conduits and a resin source 110. In some embodiments, the resin includes polyether ether ketone, polyether ketone ketone, polysulfone, polyethersulfone, polyether imide, polyamide, polybutylene terephthalate, nylon, polyethylene, polycarbonate, or combinations thereof or other resins used for thermoplastic composites. In some embodiments, resin extruder 108 is a thermoplastic screw extruder, such as a Filabot EX2 or equivalent. In these embodiments, resin extruder 108 is fed thermoplastic pellets which are moved and melted inside a rotating extrusion screw to extrude a feed of resin to, for example, one or more of the resin supply conduits and at a controlled rate.

Referring now to FIG. 4B (section Y-Y from FIG. 4A) and FIG. 4C (section X-X from FIG. 4A), and as discussed above, in some embodiments, impregnation die 106 includes one or more resin supply conduits 402. In some embodiments, impregnation die 106 includes a first resin supply conduit 402A and at least a second resin supply conduit 402B. In some embodiments, each of first resin supply conduit 402A and second resin supply conduit 402B are fed by the same resin extruder 108. In some embodiments, first resin supply conduit 402A and second resin supply conduit 402B are fed by separate resin extruders. In some embodiments, first resin supply conduit 402A and second resin supply conduit 402B share a common delivery conduit 402D before separating into individual conduits. In other embodiments, resin is delivered to the fiber tow from only one direction, e.g., from above, below, etc. In other embodiments, resin is delivered to the fiber tow by one resin supply conduit 402A or 402B from only one direction, e.g., from above, below, etc.

In some embodiments, resin supply conduits generally converge at location L where the fiber tow is pulled through impregnation die 106. In some embodiments, a fiber tow slit 404 is positioned between first resin supply conduit 402A and second resin supply conduit 402B and further is configured to contact fiber tow, e.g., spread fiber tow FS, with a resin from the resin supply conduits, e.g., to form prepreg fiber tow FP. In some embodiments, first resin supply conduit 402A is configured to deliver resin to fiber tow slit 404 from a first direction RA. In some embodiments, second resin supply conduit 402B is configured to deliver resin to fiber tow slit 404 from a second direction RB. In some embodiments, first direction RA and second direction RB are opposing directions. In some embodiments, first direction RA is from above fiber tow slit 404 and/or the fiber tow, e.g., stream 1000. In some embodiments, second direction RB is from below fiber tow slit 404 and/or the fiber tow, e.g., stream 1000. In some embodiments, first resin supply conduit 402A and second resin supply conduit 402B deliver resin to fiber tow slit 404 simultaneously. In some embodiments, only one of first resin supply conduit 402A and second resin supply conduit 402B delivers resin to fiber tow slit 404 at any given time. In some embodiments, flow rates of resin are consistent across resin supply conduits, e.g., the flow rates from first resin supply conduit 402A and second resin supply conduit 402B are the same. In some embodiments, stream 1000, e.g., including spread fiber tow FS, is drawn through fiber tow slit 404 at a slow enough speed so that resin fully or substantially fully impregnates the entire thickness of the fiber tow by the time the fiber tow exits the impregnation die 106.

In some embodiments, resin supply conduits 402 include one or more resin supply channels 402C. In some embodiments, resin supply channels 402C are in fluid communication with resin extruder 108. In some embodiments, resin supply channels 402C are configured to deliver resin to one or more resin supply manifolds 402M. In some embodiments, resin is delivered to fiber tow slit 404 via resin supply lands 402L. In some embodiments, resin supply lands 402L provide a ribbon-shaped resin melt to the fiber tow. In some embodiments, resin supply lands 402L provide a ribbon-shaped resin melt with uniform flow rate across the fiber tow. In some embodiments, resin supply channels 402C, resin supply manifolds 402M, resin supply lands 402L, or combinations thereof, are in thermal communication with heating element 406 for the purpose of temperature control. In some embodiments, heating element 406 includes an electric resistance heater, band heater, or other suitable heat source.

In some embodiments, impregnation die 106 includes a converging die 408. In some embodiments, converging die 408 includes one or more converging channels 408C. In some embodiments, converging die 408 is configured to remove excess resin from and converge prepreg fiber tow FP, via converging channels 408C, to a finalized shape (e.g., flat tape, circular, rectangular) and size. In some embodiments, such as that shown in FIG. 4C, converging die 408 includes a single stage. In some embodiments, converging die 408 includes multiple stages. In some embodiments, converging die 408 is heated, e.g., via heating element 406, a separate heating element, etc. Without wishing to be bound by theory, the shape of converging die 408, i.e., the cross-section of converging channels 408C, dictates the final cross-section and dimensions of the fiber tow, e.g., prepreg fiber tow FP, as it exits the channels. In some embodiments, prepreg fiber tow FP is made to be greater than about 0.1 mm in thickness, greater than about 0.25 mm in thickness, greater than about 0.5 mm in thickness, greater than about 1 mm in thickness, greater than about 2 mm in thickness, greater than about 3 mm in thickness, greater than about 4 mm in thickness, greater than about 5 mm in thickness, etc. In some embodiments, prepreg fiber tow FP is made to be greater than about 1 mm wide, greater than about 5 mm wide, greater than about 10 mm wide, etc. In some embodiments, prepreg fiber tow FP is made to have a substantially circular cross-section. In some embodiments, converging die 408 is interchangeable with other converging dies having different cross-sections and/or sizes, providing flexibility to impregnation die 106 by enabling production of prepreg fiber tows with differing shape/size. In some embodiments, individual stages of converging die 408 are interchangeable.

Referring again to FIGS. 1A and 1B, in some embodiments, system 100 includes a post-processing assembly 112. Assembly 112 can have any suitable arrangement of components configured to improve the quality of prepreg fiber tow FP. Referring now to FIG. 1B, in some embodiments, assembly 112 includes one or more nip rollers 112N, e.g., for smoothing a surface of prepreg fiber tow FP.

Referring again to FIGS. 1A and 1B, in some embodiments, system 100 includes a drive assembly 114. In some embodiments, drive assembly 114 is driven by one or more motors. In some embodiments, drive assembly 114 is configured to continuously transport fiber tow, e.g., stream 1000, through system 100. In some embodiments, drive assembly 114 draws fiber tow through system 10, e.g., via pulling. In some embodiments, drive assembly 114 is positioned before tow spreader 104, after impregnation die 106, or combinations thereof. In the embodiment shown in FIGS. 1A and 1B, drive assembly 114 draws fiber tow from source 102, e.g., fiber tow FA, through tow spreader 104, e.g., spread fiber tow FS, through impregnation die 106, e.g., as prepreg fiber tow FP, and through post processing assembly 112. In some embodiments, drive assembly 114 includes one or more nip rollers, one or more drive rollers, or combinations thereof.

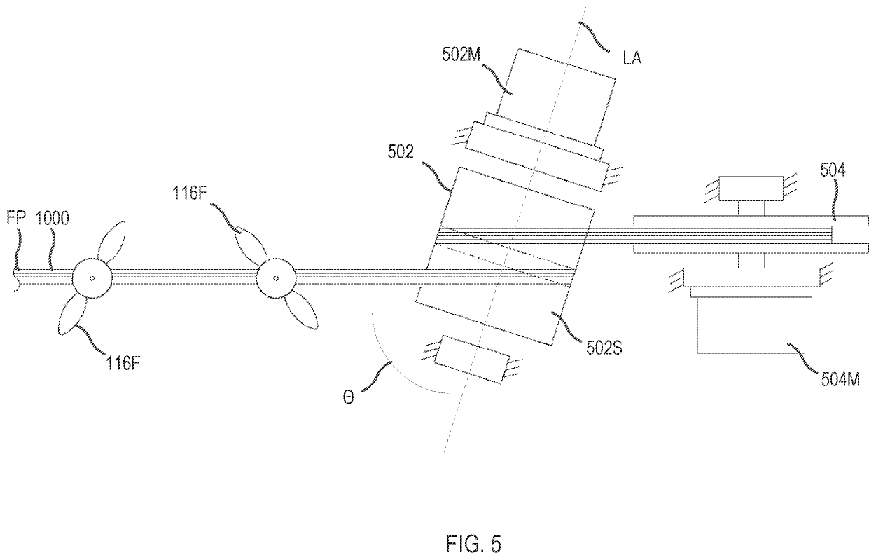

Referring now to FIG. 5, in some embodiments, drive assembly 114 includes a drive roller 502 driven by one or more motors 502M, causing the drive roller to rotate, e.g., at a substantially constant rotational speed. In some embodiments, drive roller 502 rotates continuously or substantially continuously while system 100 is in operation. In some embodiments, drive roller 502 pulls the fiber tow through system 100 by wrapping around the circumference of the roller. In some embodiments, drive roller 502 has a surface 502S with a relatively high friction surface. In some embodiments, surface 502S includes rubber, roughened metal, or combinations thereof. The fiber tow is sufficiently wrapped around drive roller 502 to provide enough upstream fiber tension to overcome dry and viscous friction in the system components. In some embodiments, velocity v of the fiber tow is substantially constant. In some embodiments, drive roller 502 has a longitudinal axis LA. In some embodiments, drive roller 502 is positioned at an angle Θ relative to the fiber tow, e.g., to stream 1000, predetermined tow path P, etc. Angling the drive roller with respect to the tape direction's normal vector causes the filament/tape to wrap around the roller as a helix and prevents slippage between the filament/tape and roller by using the capstan effect. In some embodiments, the angle Θ is less than 90°. In some embodiments, drive roller 502 has a sufficient diameter so as to prevent damage to the fiber tow, e.g., fiber breakage, due via sharp bending/wrapping. In some embodiments, drive roller 502 has a diameter greater than about 5 cm. In some embodiments, drive roller 502 has a diameter greater than about 10 cm.

Referring again to FIGS. 1A and 1B, in some embodiments, system 100 includes a cooling assembly 116. In some embodiments, cooling assembly 116 is positioned between impregnation die 106 and drive assembly 114. In some embodiments, cooling assembly 116 is positioned between post-processing assembly 112 and drive assembly 114. In some embodiments, cooling assembly 116 includes any suitable arrangement of components to cool prepreg fiber tow FP, e.g., to a temperature below the glass transition temperature of the resin in prepreg fiber tow FP. Referring specifically to FIG. 1B and FIG. 5, in some embodiments, cooling assembly 116 includes one or more fans 116F, e.g., to provide convective cooling. In some embodiments, cooling assembly 116 includes a mist or falling stream of cooling fluid that rapidly cools prepreg fiber tow FP.

Referring again to FIGS. 1A and 1B, in some embodiments, system 100 includes a take-up assembly 118. In some embodiments, take-up assembly 118 is configured to collect impregnated fiber tow, e.g., prepreg fiber tow FP. In some embodiments, take-up assembly 118 collects impregnated fiber tow from impregnation die 106, post-processing assembly 112, cooling assembly 116, drive assembly 114, or combinations thereof. Referring again to FIG. 5, in some embodiments, take-up assembly 118 includes one or more reels 504 around which prepreg fiber tow FP can wrap for storage and/or transport. In some embodiments, take-up assembly 118 is driven by one or more motors 504M, causing the take-up assembly to rotate, e.g., with low torque thereby providing low downstream tension in the prepreg fiber tow FP to the drive assembly 114. In some embodiments, take-up assembly 118 rotates continuously or substantially continuously while system 100 is in operation. In some embodiments, take-up assembly motor 504M is operated in constant torque mode to provide uniform downstream tension in prepreg fiber tow FP to the drive assembly 114. In some embodiments, take-up reel 504 is wider than the fiber two FP tape/filament. In some embodiments, additional material is incorporated into and/or between layers of prepreg fiber tow FP, including thermal management material, fibrous material, e.g., chopped fibers or nanofibers, to increase bond strength, etc., or combinations thereof. In some embodiments, prepreg fiber tow FP is then removed manually or automatically, e.g., by removing one or more reels 504 of prepreg fiber tow FP from take-up assembly 118.

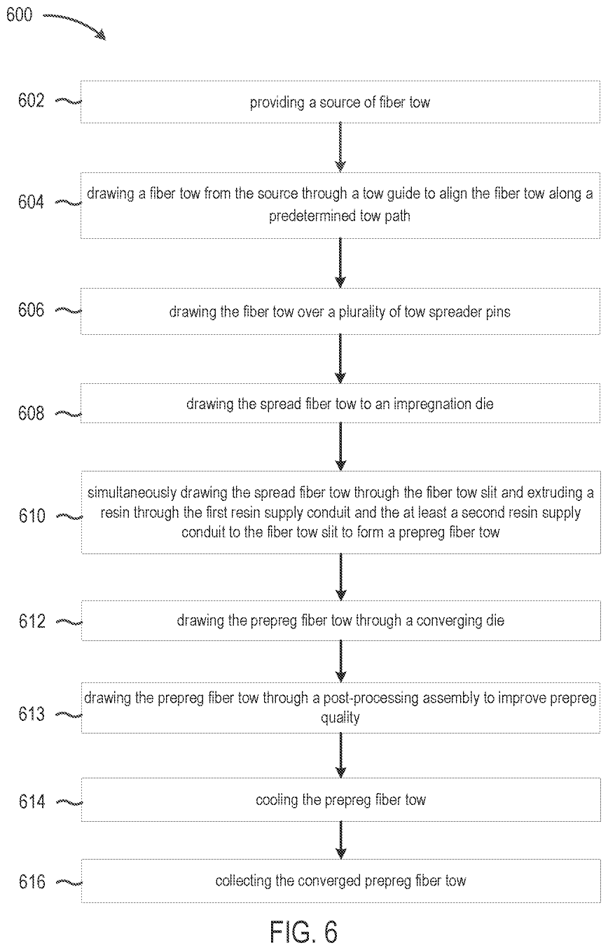

Referring now to FIG. 6, some aspects of the present disclosure are directed to a method 600 for impregnating a fiber tow. In some embodiments, at 602, a source of fiber tow is provided. At 604, a fiber tow from the source is drawn through a tow guide to align the fiber tow along a predetermined tow path. At 606, the fiber tow is drawn over a plurality of tow spreader pins. In some embodiments, as discussed above, at least one of the tow spreader pins includes a convex spreading surface aligned with the predetermined tow path to spread the fiber tow to a spread fiber tow. At 608, the spread fiber tow is drawn to an impregnation die. In some embodiments, again, as discussed above, the impregnation die includes a first resin supply conduit, at least a second resin supply conduit, and a fiber tow slit positioned between the first resin supply conduit and the at least a second resin supply conduit. In some embodiments, again, as discussed above, the impregnation die includes only a first resin supply conduit in fluid communication with the fiber tow slit. In some embodiments, at 610, the spread fiber tow is drawn through the fiber tow slit and a resin is simultaneously extruded through the first resin supply conduit and the at least a second resin supply conduit to the fiber tow slit to form a prepreg fiber tow. As discussed above, in some embodiments, resin is only extruded through a single resin supply conduit, e.g., a lone resin supply conduit, alternating between a first resin supply conduit and other resin supply conduits, etc. At 612, the prepreg fiber tow is drawn through a converging die configured to remove excess resin from and converge the prepreg fiber tow. In some embodiments, at 613, the prepreg fiber tow is drawn through a post-processing assembly, e.g., to improve prepreg quality. In some embodiments, at 614, the prepreg fiber tow is cooled after the converging die. At 616, the converged prepreg fiber tow is collected.

Methods and systems of the present disclosure provide a system to continuously and rapidly impregnate a source of fiber tow. The methods and systems reduce costs significantly by using raw fiber tow materials. The tow spreader takes raw fiber tow as an input and outputs a flat, uniformly distributed tow, a conformation which is maintained by the system through the impregnation die for coating and impregnating with resin. The impregnation die is then able to coat the spread fiber tow from one or more directions and converge the tow back to a consolidated fiber conformation to more thoroughly impregnate the fiber tow and prepare it for use in FDM-like or AFP-like processes, e.g., being manipulated by a 3-axis CNC platform or a CNC-controlled filament tape winding apparatus with a spinning mandrel for mandrel wrapping or automated fiber placement.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for impregnating a fiber tow, comprising:
a source of fiber tow, the fiber tow having a first thickness;
a tow spreader including one or more spreading surfaces, the spreading surfaces configured to spread the fiber tow from the source of fiber tow to form a spread fiber tow having second thickness, wherein the first thickness is greater than the second thickness;
an impregnation die positioned to receive the spread fiber tow, the impregnation die including:
one or more thermoplastic resin supply conduits; and
a fiber tow slit positioned between the resin supply conduits, the fiber tow slit configured to contact the spread fiber tow with a thermoplastic resin from the resin supply conduits on one or both sides of the tow to form a prepreg fiber tow;
a resin extruder configured to deliver the thermoplastic resin to the resin supply conduits; and
a drive assembly rotating at substantially constant rotation speed configured to continuously transport a fiber tow from the source and through the tow spreader and impregnation die.

2. The system according to claim 1, wherein the fiber tow includes carbon, glass, one or more polymers, one or more minerals, or combinations thereof.

3. The system according to claim 1, wherein the resin includes polyether ether ketone, polyether ketone ketone, polysulfone, polyethersulfone, polyether imide, polyamide, polybutylene terephthalate, nylon, polyethylene, polycarbonate, or combinations thereof or other resins used for thermoplastic composites.

4. The system according to claim 1, wherein the source of fiber tow includes one or more spools of fiber tow, wherein the source of fiber tow includes a friction brake to provide torsional resistance to rotation of the spools and slight tension in the fiber tow.

5. The system according to claim 1, wherein the spreading surfaces have a longitudinal axis perpendicular to the fiber tow in the tow spreader, the spreading surfaces having a convex surface profile along the longitudinal axis.

6. The system according to claim 5, wherein the convex surface profile has a constant radius of curvature.

7. The system according to claim 5, wherein the tow spreader includes one or more pins, wherein one or more of the spreading surfaces are positioned on the pins.

8. The system according to claim 7, wherein at least one of the pins includes a radial groove having a planar surface profile.

9. The system according to claim 1, wherein the impregnation die includes a first resin supply conduit and a second resin supply conduit, wherein the first resin supply conduit is positioned to deliver resin to the fiber tow slit from a first direction and the second supply conduit is positioned to simultaneously deliver resin to the fiber tow slit from a second direction, wherein the first direction is opposite the second direction.

10. The system according to claim 9, wherein the first direction is from above the spread fiber tow and the second direction is from below the spread fiber tow.

11. The system according to claim 1, further comprising a converging die configured to remove excess resin from the prepreg fiber tow, shape the prepreg fiber tow into a two-dimensional cross-sectional shape, converge the prepreg fiber tow to a third thickness, wherein the third thickness is greater than the second thickness, or combinations thereof.

12. The system according to claim 1, wherein the drive assembly includes a speed-controlled drive roller, wherein a longitudinal axis of the drive roller is positioned at an angle Θ relative to the fiber tow, wherein the angle Θ is less than 90°.

13. The system according to claim 14, wherein the drive roller has a diameter greater than about 10 cm.

14. A method for impregnating a fiber tow, comprising:
providing a source of fiber tow;
drawing a fiber tow from the source through a tow guide to align the fiber tow along a predetermined tow path;
drawing the fiber tow over a plurality of tow spreader pins, at least one of the tow spreader pins including a convex spreading surface aligned with the predetermined tow path to spread the fiber tow to a spread fiber tow;
drawing the spread fiber tow to an impregnation die, the impregnation die including a first resin supply conduit, at least a second resin supply conduit, and a fiber tow slit positioned between the first resin supply conduit and the at least a second resin supply conduit;
simultaneously drawing the spread fiber tow through the fiber tow slit and extruding a resin through the first resin supply conduit and the at least a second resin supply conduit to the fiber tow slit to form a prepreg fiber tow;
drawing the prepreg fiber tow through a converging die configured to remove excess resin from and converge the prepreg fiber tow;
drawing the prepreg fiber tow through a post-processing assembly to improve prepreg quality; and
collecting the converged prepreg fiber tow.

15. The method according to claim 14, further comprising cooling the prepreg fiber tow after the converging die.

16. The method according to claim 14, wherein the fiber tow is drawn via wrapping around a drive roller, wherein a longitudinal axis of the drive roller is positioned at an angle Θ relative to the fiber tow, wherein the angle Θ is less than 90°.

17. A system for impregnating a fiber tow, comprising:
a source of fiber tow;
a tow guide to align the fiber tow from the fiber tow source along a predetermined tow path;
a plurality of tow spreader pins, at least one of the tow spreader pins including a convex spreading surface aligned with the predetermined tow path to spread the fiber tow to a spread fiber tow;
an impregnation die positioned to receive the spread fiber tow, the impregnation die including:
at least a first resin supply conduit and at least a second resin supply conduit;
a fiber tow slit positioned between the first resin supply conduit and the at least a second resin supply conduit and configured to contact the spread fiber tow with a resin from the resin supply conduits to form a prepreg fiber tow; and
a heating element configured to maintain a predetermined temperature within the first resin supply conduit and the at least a second resin supply conduit;
wherein the first resin supply conduit is positioned to deliver resin to the fiber tow slit from a first direction and the at least a second resin supply conduit is positioned to simultaneously deliver resin to the fiber tow slit from a second direction, wherein the first direction is opposite the second direction;
a converging die configured to remove excess resin from and converge the prepreg fiber tow;
a drive roller configured to pull the fiber tow from the source and through the tow guide, tow spreader pins, impregnation die, and converging die, wherein a longitudinal axis of the drive roller is positioned at an angle θ relative to the fiber tow; and
a post-processing assembly positioned between the converging die and cooling assembly to improve prepreg quality.

18. The system according to claim 17, further comprising a cooling assembly positioned between the converging die and the drive roller.

19. The system according to claim 17, wherein the fiber tow includes carbon, glass, one or more polymers, one or more minerals, or combinations thereof.

20. The system according to claim 17, wherein the resin includes polyether ether ketone, polyether ketone ketone, polysulfone, polyethersulfone, polyether imide, polyamide, polybutylene terephthalate, nylon, polyethylene, polycarbonate, or combinations thereof or other resins used for thermoplastic composites.
